(19) United States
(12) Patent Application Publication
(10) Pub. No.: US 2022/0230070 A1
(43) Pub. Date: Jul. 21, 2022

(54) System and Method for Automated Multi-Objective Policy Implementation, Using Reinforcement Learning

(71) Applicant: B.G. NEGEV TECHNOLOGIES AND APPLICATIONS LTD., AT BEN-GURION UNIVERSITY, Beer Sheva (IL)

(72) Inventors: Asaf Shabtai, Hulda (IL); Gilad Katz, Tel Aviv (IL); Yoni Birman, Lod (IL); Shaked Hindi, Hadera (IL)

(21) Appl. No.: 17/611,641

(22) PCT Filed: May 14, 2020
(86) PCT No.: PCT/IL2020/050527

§ 371 Date: Nov. 16, 2021

Related U.S. Application Data
(60) Provisional application No. 62/848,608, filed on May 16, 2019.

(51) Int. Cl. G06N 3/08; G06K 9/62

(52) U.S. Cl. CPC G06N 3/088; G06K 9/6262

(57) ABSTRACT

An automatic computer implemented method for making classification decisions to provide a desired policy that optimizes multi-objective tasks with contradicting constrains. Time and resources constrains that correspond to a predetermined level of acceptable cost are defined, as well as a cost function that represents the acceptable cost while considering the constrains. A plurality of analysis and processing modules are deployed in a computational environment, for processing data associated with the computational environment and returning results, along with indications regarding the level of confidence of the results. providing at least one agent for evaluating the results returned by each module, using a neural network being trained to dynamically determine when the level of confidence is sufficient, using one module, and if found insufficient, using more modules. Rewards are assigned to sufficient levels and penalties to insufficient levels, to the usage of resources and to runtime, using a RL framework for exploring the efficacy of various modules combinations and continuously performing cost-benefit analysis. The RL framework is used for analyzing the required consumed resources and processing time corresponding to the cost function and selecting the optimal combinations of modules to implement the policy.

### FIELD OF THE INVENTION

The present invention relates to the field of resource usage optimization. More particularly, the present invention relates to a system and method for automated policy implementation that optimizes between multi-objective tasks with contradicting constrains, using reinforcement learning.

### BACKGROUND OF THE INVENTION

Many technological fields, such as medical tests and diagnostics, detection of various illnesses or medical conditions, diagnostic test, maintenance facilities for vehicles, ships, drones and planes require testing and analysis, in order to optimize the usage of resources, in order to achieve multi-objective tasks with contradicting constrains. However, the attempt to satisfy all constraints is very difficult, and heuristic solutions result in sub-optimal policies. For example, medical examination and diagnostics may require several tests, some of which may be very expensive (e.g., MRI), without real need. The same applies when there is a need to decide which maintenance measures should be taken by garages in order to keep vehicles maintained properly and prevent failures.

Supervised learning solutions (e.g., classification algorithms) are not ideal for these scenarios because the partial information available halfway through the process is not suitable for the training of the models. Reinforcement learning is far more suitable for such scenarios, but to-date no solution exists for solving multi-objective problems, in which some of the objectives are contradictory (e.g., accuracy vs. resource usage).

Other systems that require such optimization are computerized systems and data networks. For example, malware detection is a lasting problem for organizations, often with significant consequences [2]. Portable Executable (PE) files (the PE format is a file format for executables, object code, DLLs and others used in 32-bit and 64-bit versions of Windows operating systems) are one of the most significant platforms for malware to spread. PEs are common in the Windows operating systems and are used by executables and Dynamic Link Libraries (DLLs), among others. The PE format is essentially a data structure which holds all the necessary information for the Windows loader to execute the wrapped code.

Malware constantly evolve as attackers try to evade detection solutions, the most common of which is the anti-virus. Anti-virus solutions mostly perform static analysis of the software's binary code to detect pre-defined signatures, a trait that renders them ineffective in recognizing new malware even if similar functionality has been recorded. Obfuscation techniques such as polymorphism and metamorphism [33] further exacerbate the problem.

In recent years, the need to deal with the continuously evolving threats led to significant developments in the malware detection field. Instead of searching for pre-defined signatures within the executable file, new methods attempt to analyze the behavior of the portable executable (PE) file. These methods often rely on statistical analysis and Machine Learning (ML) techniques as their decision making mechanism, and can generally belong to one of two families: static analysis and dynamic analysis [18].

Static analysis techniques [29] employ an in-depth look at the file, without performing any execution. Solutions implementing static analysis can be either signature-based or statistics-based. Signature-based detection is the more widely used approach [6] because of its simplicity, relative speed and its effectiveness against known malware. However, signature-based detection has three major drawbacks:
it requires frequent updates of its signature database;
it cannot detect unknown (i.e., zero-day) malware [6];
it is vulnerable to obfuscation techniques [33].

Statistics-based detection mainly involves the extraction of features from the executable, followed by training of a machine learning classifier. The extracted features vary and may include executable file format descriptions [19], code descriptions [23], binary data statistics [17], text strings [5] and information extracted using code emulation or similar methods [33]. This method is considered more effective than its signature-based counterpart in detecting previously unknown malware, mostly due to using machine learning (ML) [3, 5, 7, 10, 23], but tends to be less accurate overall [20]. For this reason, organizations often deploy an ensemble of multiple behavioral and statistic detectors, and then combine their scores to produce final classification. This classification process can be achieved through simple heuristics (e.g., averaging) or by more advanced ML algorithms [12].

However, the ensemble approach has two significant drawbacks. First, using an ensemble requires that organizations run all participating detection tools prior to classifying a file, so as to make scoring consistent and because most ML algorithms (like those often used to reach the final ensemble decision) require a fixed-size feature set. Running all detectors is intensive, time and resources consuming and is often not necessary for clear-cut cases, so computing resources are wasted. Moreover, the introduction or removal of a detector often requires that the entire ML model will be retrained. This limits flexibility and the organization's ability to respond to new threats.

The second drawback of the ensemble approach is the difficulty of implementing the organizational security policy. When using ML-based solutions for malware detection, the only “tool” available for organizations to set their policy is the final confidence score: files above a certain score are blocked, while the rest are allowed to enter. Under this setting, it is difficult to define the cost of a false-negative compared to that of a false-positive, or to quantify the cost of running additional detectors. In addition of being hard to define, such security policies are also hard to refine: minor changes in the confidence score threshold may result in large fluctuations of performance (e.g., significantly raising the number of false-alarms).

Deep Reinforcement Learning (DRL)

Reinforcement Learning (RL) is an area of machine learning that addresses decision making in complex scenarios, possibly when only partial information is available. The ability of RL algorithms to explore the large solution spaces and devise highly efficient policies to address them (especially when coupled with deep learning) was shown to be highly effective in areas such as robotics and control problems [21], genetic algorithms [26], and achieving super-human performance in complex games [25].

RL tasks normally consist of both an agent and an environment. The agent interacts with the environment E in a sequence of actions and rewards. At each time-step t, the agent selects an action aₜ from A={a₁, a₂, . . . , aₖ} that that both modifies the state of the environment and also incurs a reward rₜ, which is either positive or negative (the term “cost” is used to describe negative rewards). The goal of the agent is to interact with the environment in a way that maximizes future rewards Rₜ=Σₜ^{T} rₜ in time-span {t . . . T}, where T is the index of the final action (i.e., classification decision). A frequent approach for selecting the action to be taken at each state is the action-value function Q(s,a) [27]. The function approximates the expected returns one should take action a as a state s. While the methods are varied, RL algorithms which use Q-functions aim to discover (or closely approximate) the optimal action-value function Q* which is defined as where π is Q*(s,a)=max_{π} [symbol] |Rₜ|sₜ=s, aₜ=a, π| the policy mapping states to actions [27].

Since estimating Q for every possible state-action combination is highly impractical [14], it is common to use an approximator Q(s,a;θ)≈Q*(s,a) where θ represents the parameters of the approximator. Deep Reinforcement learning (DRL) algorithm performs this approximation using neural nets, with θ being the parameters of the network.

While RL algorithms strive to maximize the reward based on their current knowledge (i.e., exploitation), it is important to also encourage the exploration of other additional states. Many methods for maintaining this exploration/exploitation balance have been proposed, including importance sampling [22], &greedy sampling [30] and Monte-Carlo Tree search [24]. The method of the present invention uses &greedy sampling.

Actor-Critic Algorithms for Reinforcement Learning

Two common problems in the application of DRL algorithms: (1) the long time they need to converge due to high variance (i.e., fluctuations) in gradient values, and (20 the need to deal with action sequences with a cumulative reward of zero (zero reward equals zero gradients, hence no parameter updates). These challenges can be addressed by using actor-critic methods, consisting of a critic neural net that estimates the Q-function and an actor neural net that updates the policy according to the critic neural net.

Using two separate networks has been shown to reduce variance and accelerate model convergence during training. In an experiments performed, the Actor-Critic with Experience Replay (ACER) algorithm [32] was used. Experience replay [13] is a method for re-introducing the model to previously seen samples in order to prevent catastrophic forgetting (i.e., forgetting previously learned scenarios while tacking new scenarios).

The evolving threat of malware creates an incentive for organizations to diversify their detection capabilities. As a result, organizations often install multiple solutions [11] and run them all for every incoming file. This approach is both costly—in computing resources, processing time, and even the cost of electricity—and often unnecessary since most files can be easily classified.

A logical solution to this problem can be using a small number of detectors for clear-cut cases and a larger ensemble for difficult-to-analyze files. However, this solution is hard to implement for two reasons. The first challenge is assigning the right set of detectors for each file. Ideally, one would like this set to be sufficiently large to be accurate but also as small as possible so it is computationally-efficient. Striking this balance is a complex task, especially when a large number of detectors are available. The second challenge is the fact that different organizations have different preferences when facing the need to balance between detection accuracy, error-tolerance, and the cost of computing resources. Using these preferences to guide detector selection is difficult.

The conventional existing ensemble solutions require running all detectors prior to classification. This requirement is a result of the supervised learning algorithm (e.g., SVM, Random Forest) often used for this purpose. As a result, conventional solutions are unable to address the first challenge and are extremely constrained in addressing the second. challenge

Even without considering the issue of computational cost (which is moot due to the use of all detectors for each file), obtaining the right balance between different types of classification errors (false positive (FP) and false negative (FN)) remains a challenge. Usually, the only “tool” available for managing this trade-off is the confidence threshold, a value in the range of [0, 1], designating the level of certainty by classifier of the file being malicious. However, small changes in this value can cause large fluctuations in detection performance. Also recent studies [8] suggest that the confidence score is not a sufficiently reliable indicator.

Other methods use many classifiers in order to increase the detection level. However, these methods are time and hardware consuming.

It is therefore an object of the present invention to provide efficient reinforcement learning-based framework for automated policy implementation, while optimizing between multi-objective tasks with contradicting constrains.

It is another object of the present invention to provide efficient reinforcement learning-based framework for defining the contradicting constrains as a problem with efficient solution.

It is a further object of the present invention to provide efficient reinforcement learning-based framework for automatically learning a security policy that best fits organizational requirements.

It is still another object of the present invention to provide a reinforcement learning-based framework for managing a malware detection platform consisting of multiple malware detection tools.

It is yet another object of the present invention to provide a reinforcement learning-based framework for automatically learning a security policy that best fits organizational requirements.

Other objects and advantages of the invention will become apparent as the description proceeds.

### SUMMARY OF THE INVENTION

An automatic computer implemented method for making classification decisions to provide a desired policy that optimizes multi-objective tasks with contradicting constrains, comprising the steps of:
a) defining time and resources constrains that correspond to a predetermined level of acceptable cost;
b) defining a cost function that represents the acceptable cost while considering the constrains;
c) providing a plurality of analysis and processing modules in a computational environment, for processing data associated with the computational environment and returning results, along with indications regarding the level of confidence of the results;
d) providing at least one agent being a software module, for evaluating the results returned by each analysis and processing module, using a neural network being trained to dynamically determine when the level of confidence is sufficient, using one module, and if found insufficient, using more analysis and processing modules;
e) assigning rewards to sufficient levels and penalties to insufficient levels;
f) assigning penalties to the usage of resources;
g) assigning penalties to runtime using a RL framework for exploring the efficacy of various modules combinations and continuously performing cost-benefit analysis; and
h) using RL framework for analyzing the required consumed resources and processing time corresponding to the cost function and selecting the optimal combinations of analysis and processing modules to implement the policy.

Various processing modules may be sequentially queried for indications, while after each sequential step, deciding whether or not to perform further analysis by other processing modules.

The reinforcement learning algorithms may be designed to operate, based on partial data, without running all processing modules in advance.

A single processing module may be interactively selected, while during each iteration, the performance of the selected detector is evaluated, to determine whether the benefit of using additional processing modules is likely to be worth the cost of using the additional processing modules.

The selection of processing modules may be dynamic, while using different modules combinations for different scenarios.

The time required to run a processing module may represent the approximated cost of its activation.

The computational cost of using a processing module may be calculated as a function of its level of confidence.

The security policy may be managed using different cost/reward combinations.

The detector combinations may be not chosen in advance but iteratively, with the confidence level of the already-applied detectors used to guide the next step chosen by the policy.

An agent trained in a first environment may have transferability feature to function in a second environment, based on training in the first environment.

An automatic computer implemented method for making classification decisions to provide a desired policy reflecting organizational priorities, that optimizes between multi-objective tasks with contradicting constrains, comprising the steps of:
a) defining time and computational resources constrains that correspond to predetermined a level of acceptable cost;
b) defining a cost function that represents the acceptable cost while considering the constrains;
c) providing a plurality of detectors deployed in a computational environment, for classifying one or more received data files associated with the computational environment;
d) providing at least one agent for evaluating the classification results of each detector using a deep neural network being trained to dynamically determine when there is sufficient information to classify the data file using one detector, and if found insufficient, using more detectors;
e) assigning rewards to correct file classification and penalties to incorrect file classification;
f) assigning rewards to the usage of computing resources being below a predetermined level and penalties to the usage of computing resources exceeding the predetermined level;
g) assigning rewards to runtime being below a predetermined level and penalties to runtime exceeding the predetermined level using a RL framework for exploring the efficacy of various detector combinations and continuously performing cost-benefit analysis;
h) using RL framework for analyzing the cost function and selecting the optimal detector combinations for the policy.

Various detectors may be sequentially queried for each file, while after each sequential step, deciding whether or not to further analyze the file or to produce final classification.

The reinforcement learning algorithms may be designed to operate, based on partial knowledge, without running all detectors in advance.

A single detector may be interactively selected, while during each iteration, the performance of the selected detector is evaluated, to determine whether the benefit of using additional detectors is likely to be worth the computational cost of the additional detectors.

The selection of detectors may be dynamic, while using different detector combinations for different scenarios.

The states that characterize the environment may consist of all possible score combinations by the participating detectors.

The initial state for each incoming file may be a vector entirely consisting of −1 values and after various detectors are chosen to analyze the files, entries in the vector are populated with the confidence scores they provide.

The rewards reflect the organizational security policy, may be the tolerance for errors in the detection process and the cost of using computing resources.

The time required to run a detector may represent the approximated cost of its activation.

The cost function of the computing time may be defined as

$$C ( t ) = \{ \begin{matrix}t & if 0 \leq t \leq 1 \\ min \{ 1 + {log}_{2} ( t ) , 6 \} & if t > 1\end{matrix} \qquad ( 2 )$$

The cost to be considered may be adapted to include one or more of the following additional resources:

memory usage;
CPU runtime;
cloud computing costs;
electricity consumption.

The detectors may be selected from the group of pefile, byte3g, opcode2g, and manalyze.

The computational cost of using a detector may be calculated as a function of correct/incorrect file classification.

The computational costs of the detectors may be defined, based on the average execution time of the files that were used for training.

The reward for correct classification and the cost of incorrect classification may be set to be equal to the cost of the running time.

The security policy may be managed using different cost/reward combinations.

In one aspect, the detector combinations are not chosen in advance but iteratively, with the confidence score of the already-applied detectors used to guide the next step chosen by the policy.

The computational environment may include malware detection in data files.

The computational environment may include medical data files.

The reward for correct classification and the penalty for correct classification may be time dependent.

The reward for correct classification may be fixed and the penalty for correct classification may be time dependent.

An agent trained in a first environment may have transferability feature to function in a second environment, based on training in the first environment.

The environment may include one of the following:
Detection of malicious websites;
Fraud detection;
Evaluating credit risks;
Maintenance and routine inspections;
Optimized micro-power grids;
Traffic and transportation control;
an environment that requires multi-objective optimization.

A computerized system for making classification decisions to provide a desired policy that optimizes multi-objective tasks with contradicting constrains, comprising:
a) a plurality of analysis and processing modules in a computational environment, for processing data associated with the computational environment and returning results, along with indications regarding the level of confidence of the results;
b) at least one processor and associated memory, adapted to:
   b.1) store and run at least one agent being a software module, for evaluating the results returned by each analysis and processing module using a neural network, being trained to dynamically determine when the level of confidence is sufficient, using one analysis and processing module, and if found insufficient, using more analysis and processing modules;
   b.2) assign rewards to sufficient levels and penalties to insufficient levels;
   b.3) assign penalties to the usage of resources;
   b.4) assign penalties to runtime using a RL framework for exploring the efficacy of various modules combinations and continuously performing cost-benefit analysis; and
   b.5) use RL framework for analyzing the required consumed resources and processing time corresponding to the cost function and selecting the optimal combinations of analysis and processing modules to implement the policy.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a high-level architecture of the system, according to an embodiment of the present invention;

FIG. 2 shows an example of a state vector;

FIG. 3 shows a graph of a distribution of files in the dataset based, on confidence score assigned to them by each detector;

FIG. 4 shows an experimental setup infrastructure architecture; and

FIG. 5 shows a graph of a distribution of the choices made by the agent in each performed experiment.

### DETAILED DESCRIPTION OF THE INVENTION

The present invention may be implemented on malware detection and proposes a method for automated security policy implementation, using reinforcement learning.

The reinforcement learning-based framework that manages malware detection consisting of multiple malware detection tools. For each file, the proposed method sequentially queries various detectors, and after each step, decides whether or not to further analyze the file or to produce final classification. The decision-making process of the proposed automated security policy implementation is governed by a pre-defined reward function that awards points for correct classifications and applies penalties for misclassification and for heavy consumption of computing resources.

The use of reinforcement learning offers a solution to both problems. Firstly, this type of algorithms enables practitioners to assign clear numeric values to each classification outcome, as well as to quantify the cost of computing resources. These values reflect the priorities of the organization, and can be easily adapted and refined as required.

Secondly, once these values have been set, the reinforcement learning algorithm automatically attempts to define a policy (i.e., strategy) that maximizes them. This policy is likely to reflect organizational priorities much more closely than the use of a confidence threshold. Finally, since reinforcement learning algorithms are designed to operate, based on partial knowledge, there is no need to run all detectors in advance. Instead, the proposed algorithm interactively selects a single detector, evaluates its performance and then determines whether the benefit of using additional detectors is likely to be worth their computational cost. Also, the selection of detectors is dynamic, with different detector combinations used for different scenarios.

The proposed method has two advantages over existing ensemble-based solutions. First, it is highly efficient, since easy-to-classify files are likely to only require the use of less-powerful (i.e. efficient) classifiers. One can therefore maintain near-optimal performance at a fraction of the computing cost. Secondly, organizations can clearly and deliberately define and refine their security policy. This goal is achieved by enabling practitioners to explicitly define the costs of each element of the detection process, i.e., correct or incorrect classification and the associated resource consumption.

The proposed method is able to achieve near-optimal accuracy of 96.21% (compared to an optimum of 96.86%) at approximately 20% of the running time of this baseline.

In addition, it allows conducting an extensive analysis of multiple security policies, designed to simulate the needs and goals of different organizational types. The proposed method has been found to be robust, and analyzes the effect of various policy preferences on detection accuracy and resource consumption.

Moreover, the proposed method enables releasing the dataset used in the evaluation for general use. In addition to the files themselves, it enables releasing for each file the confidence scores and meta-data of each of the malware detectors used.

The main goal of the present invention is to automatically learn a security policy that best fits organizational requirements. Specifically, a deep neural network is trained to dynamically determine when there is sufficient information to classify a given file, and when more analysis is needed. The policy produced by the present invention is shaped based on the values (i.e., rewards and costs) assigned to correct and incorrect file classifications, as well as to the use of computing resources. An RL framework explores the efficacy of various detector combinations and continuously performs cost-benefit analysis, so as to select optimal detector combinations.

The main challenge in selecting detector combinations can be modelled as an exploration/exploitation problem. While the cost (i.e., computing resources consumption) of using a detector can be very closely approximated in advance, its benefit (i.e., the usefulness of the analysis) can only be known in retrospect. RL algorithms perform well in scenarios with high uncertainty where only partial information is available, a fact that makes them highly suitable for the task at hand.

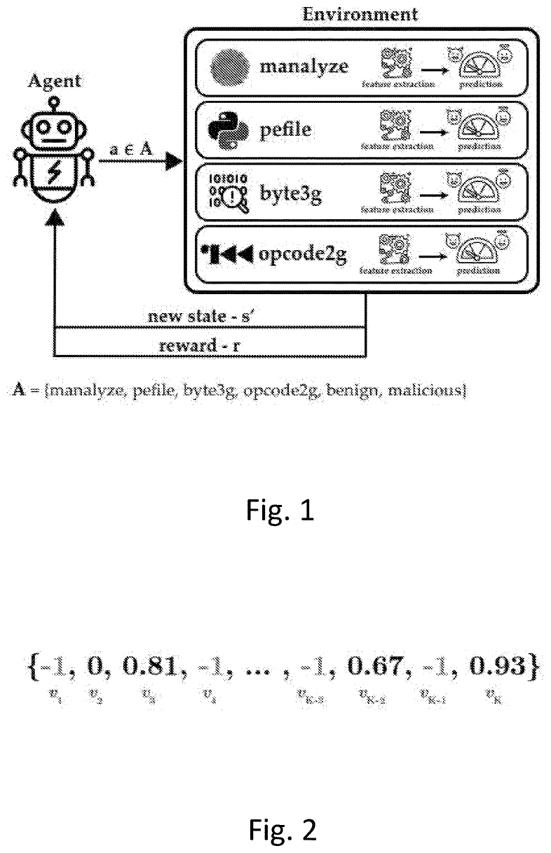

FIG. 1 illustrates the proposed architecture, describing the interaction between the agents and the environment.

The states that characterize the environment consist of all possible score combinations by the participating detectors. More specifically, for a malware detection environment consisting of K detectors, each possible state will be represented by a vector:

V={v₁, v₂, . . . v_{K}}, with the value of vₓ being set by:

$${υ}_{x} = \{ \begin{matrix}[ 0 , 1 ] & if detector x has been applied \\ - 1 & otherwise\end{matrix} \qquad ( 1 )$$

Therefore, the initial state for each incoming file is a vector entirely consisting of −1 values. As various detectors are chosen to analyze the files, entries in the vector are populated with the confidence scores they provide. All scores are normalized to a [0,1] range, where a confidence value of 1 indicates full certainty of the file being a malware and 0 indicates full certainty in its being benign. An example of a possible state vector can be seen at FIG. 2.

The number of possible actions directly corresponds to the number of available detectors in the environment. For an environment consisting of K detectors, the number of actions will be K+2: one action for the activation of each detector, and two additional actions called “malicious” and “benign”. Each of the two additional actions produces a classification decision for the analyzed file, while also terminating the analysis process.

The rewards should be designed so that they reflect the organizational security policy, namely the tolerance for errors in the detection process and the cost of using computing resources:

Two types of detection errors should be considered: false-positives (FP), which is the flagging of a benign file as malicious (i.e., a “false alarm”), and false-negative (FN), which is the flagging of a malicious file as benign. In addition to the negative rewards incurred by misclassification, it is also possible to provide positive reward for cases where the algorithm was correct.

Computing resources: The time required to run a detector has been chosen as the approximated cost of its activation. In addition to being a close approximator of other types of resources use (e.g., CPU, memory), the run time is a clear indicator of an organization's ability to process large volumes of incoming files. Hence, reducing the average time required to process a file allows organizations to process more files with less hardware.

When designing the reward function for the analysis runtime, it is required to address the large difference in this measure between various detectors.

As shown in Table 2 below, average running times can vary by orders of magnitude (from 0.7 s to 44.29 s, depending on the detector). In order to mitigate these differences and encourage the use of the more “expensive” (but also more accurate) detectors, the cost function of the computing time is defined as follows:

$$C ( t ) = \{ \begin{matrix}t & if 0 \leq t \leq 1 \\ min \{ 1 + {log}_{2} ( t ) , 6 \} & if t > 1\end{matrix} \qquad ( 2 )$$

While only considering running time as the computing resource whose cost needs should be considered, the method proposed by the present invention can be easily adapted to include additional resources, such as memory usage, CPU runtime, cloud computing costs and electricity consumption. The proposed method allows organizations to easily and automatically integrate all relevant costs into their decision making process.

Dataset Malware Detection Analysis

The dataset used by present invention consists of 24,737 PE files, equally divided between malicious and benign PE files. Since it was impossible to determine the creation time of each file, all files were collected from the repositories of the network security department of a large organization in October 2018. Each file was analyzed using four different malware detectors.

The selection of detectors was guided by three objectives:
Off-the-shelf software: The ability to use malware detection solution without any special adaptation demonstrates that the present invention method is generic and easily applicable.
Proven detection capabilities: By using detectors that are also in use in real-world organizations the validity of the experiments is ensured.
Run-time variance: Since the goal of the experiments is to demonstrate the ability of the proposed method to perform cost-effective detection (with running time being the chosen cost metric), using detection solutions that vary in their resource requirements was deemed preferable. Such variance is consistent with real-world detection pipelines that combine multiple detector “families” [11].

Following the above-mentioned objectives, four detectors were selected to be included in the present invention dataset: pefile, byte3g, opcode2g, and manalyze.

Pefile detector: This detector uses seven features extracted from the PE header: DebugSize, ImageVersion, latRVA, ExportSize, ResourceSize, VirtualSize2, and NumberOfSections, presented in [19]. Using those features, a Decision Tree classifier was trained to produce the classification.

byte3g: This detector uses features extracted from the raw binaries of the PE file [17]. Firstly, it constructs trigrams (3-grams) of bytes. Secondly, it computes the trigrams term-frequencies (TF), which are the raw counts of each trigram in the entire file. Thirdly, the document-frequencies (DF) are calculated, which represent the rarity of a trigram in the entire dataset. Lastly, since the amount of features can be substantial (up to 256³), the top 300 DF-valued features were used for classification. Using the selected features, a Random Forest classifier with 100 trees was trained.

opcode2g: This detector uses features based on the disassembly of the PE file [16]. First, it disassembles the file and extracts the opcode of each instruction. Secondly, it generates bigrams (2-grams) representation of the opcodes. Thirdly, both the TF and DF values are computed for each bigram. Lastly, once again it selects the 300 features with the highest DF values. Using the selected features, a Random Forest classifier with 100 trees was trained.

manalyze: This detector is based on open-source heuristic scanning tool named Manalyze³. It offers multiple types of static analysis capabilities for PE files, each implemented in a separate “plugin”. In the present invention version the following capabilities were included: packed executables detection, ClamAV and YARA signatures, detection of suspicious import combinations, detection of cryptographic algorithms, and the verification of Authenticode signatures. Each plugin returns one of three values: benign, possibly malicious, and malicious. Since Manalyze does not offer an out-of-the-box method for combining the plugin scores, a Decision Tree classifier with the plugins' scores as features was trained.

Detectors Performance Analysis

The performance of the various detectors was analyzed and compared. The effectiveness of various detector combinations was explored.

Overall Detector Performance

At the beginning, analysis of the upper bound on the detection capability of the four detectors was performed. Table below 1 presents a breakdown of all files in the present invention's dataset as a function of the number of times they were incorrectly classified by the various detectors. All detectors were trained and tested using 10-fold cross-validation. Incorrect classification is defined as a confidence threshold above 0.5 for a benign file or one that is equal or smaller than 0.5 for a malicious file.

TABLE 1
A breakdown of the files of our dataset based on the
number of detectors that misclassified them.

| # Misclassification | # Files | % of Files |
|---|---|---|
| 0 | 18062 | 73.02 |
| 1 | 5149 | 20.81 |
| 2 | 969 | 3.92 |
| 3 | 197 | 1.60 |
| 4 | 160 | 0.65 |

The results presented in Table 1 show that approximate 73% of all files are classified correctly by all detectors, while only 0.65% (160 files) is not detectable by any method.

This analysis leads to two conclusions: a) Approximately ˜26.5% of the files in the dataset potentially require using of multiple detectors to achieve correct classification; b) only a small percentage of files (1.6%) is correctly classified by a single classifier, which means that applying all four detectors for a given file is hardly ever required. These conclusions support the hypothesis that a cost-effective approach for using only a subset of possible detectors.

TABLE 2
The performance of the participating detectors. We
present overall accuracy, the true-positive (malware
detection) rate and the false-positive (misclassification of
benign files) rate. In addition, we present the mean running
time of each detector, calculated over all files in the dataset.
The running time and overall performance were measured
on machines utilizing the same hardware and firmware
specifications, detailed in Section 5.1.

| | Accuracy (%) | TPR | FPR | Mean Time (sec) |
|---|---|---|---|---|
| manalyze | 82.88 | 0.844 | 0.186 | 0.75 |
| pefile | 90.59 | 0.902 | 0.090 | 0.70 |
| byte3g | 94.89 | 0.937 | 0.039 | 3.99 |
| opcode2g | 95.50 | 0.951 | 0.041 | 42.99 |

Absolute and relative detector performance: The goal of this analysis is first to present the performance (i.e., detection rate) of each detector, and then determine whether any classifier is dominated by another (thus making it redundant, unless it is more computationally efficient). The analysis was begun by presenting the absolute performance of each detector. As can be seen in Table 2 above, the accuracy of the detectors ranges between 82.88%-95.5%, with the more computationally-expensive detectors generally achieving the better performance.

Next it was attempted to determine whether any detector is dominated by another. For each detector, the files it misclassified were analyzed, in order to determine whether they would be correctly classified by another detector. The results of this analysis, presented in Table 4 below, show that no detector is being dominated. Moreover, the large variance in the detection rates of other detectors for misclassified files further indicates that an intelligent selection of detector subsets (where the detectors complement each other) can yield high detection accuracy.

TABLE 3
The running time and performance of all possible malware detector combinations

| # | Detector Combination | Aggregation Method | Mean Accuracy (%) | Mean Time (sec) | FP (%) | FN (%) |
|---|---|---|---|---|---|---|
| (1) | manalyze.pefile.byte3g.opcode2g | stacking (RF) | 96.86 | 49.73 | 1.52 | 1.62 |
| (2) | manalyze.byte3g.opcode2g | majority | 96.71 | 49.03 | 1.45 | 1.84 |
| (3) | manalyze.pefile.byte3g.opcode2g | majority | 96.65 | 49.73 | 1.40 | 1.95 |
| (4) | byte3g.opcode2g | majority | 96.37 | 48.28 | 1.65 | 1.98 |
| (5) | pefile.byte3g.opcode2g | majority | 96.30 | 48.98 | 1.61 | 2.09 |
| (6) | manalyze.pefile.opcode2g | majority | 95.98 | 45.74 | 1.77 | 2.25 |
| (7) | manalyze.pefile.byte3g | majority | 95.62 | 5.44 | 1.95 | 2.43 |
| (8) | byte3g.opcode2g | or | 95.57 | 48.28 | 3.23 | 1.20 |
| (9) | manalyze.opcode2g | majority | 95.56 | 45.04 | 2.12 | 2.32 |
| (10) | opcode2g | none | 95.50 | 44.29 | 2.07 | 2.43 |
| (11) | pefile.opcode2g | majority | 95.44 | 44.99 | 2.06 | 2.49 |
| (12) | manalyze.pefile.byte3g.opcode2g | stacking (DT) | 95.16 | 49.73 | 2.48 | 2.36 |
| (13) | manalyze.byte3g | majority | 95.15 | 4.74 | 2.43 | 2.43 |
| (14) | byte3g | none | 94.89 | 3.99 | 1.96 | 3.15 |
| (15) | pefile.byte3g | majority | 94.85 | 4.69 | 2.32 | 2.83 |
| (16) | pefile.opcode2g | or | 92.99 | 44.99 | 5.81 | 1.19 |
| (17) | pefile.byte3g | or | 92.99 | 4.69 | 5.55 | 1.63 |
| (18) | pefile.byte3g.opcode2g | or | 92.83 | 48.98 | 6.58 | 0.80 |
| (19) | manalyze.pefile | majority | 92.40 | 1.45 | 3.47 | 4.14 |
| (20) | pefile | none | 90.60 | 0.70 | 4.52 | 4.88 |
| (21) | manalyze.opcode2g | or | 88.67 | 45.04 | 10.56 | 0.77 |
| (22) | manalyze.byte3g | or | 88.58 | 4.74 | 10.51 | 0.91 |
| (23) | manalyze.byte3g.opcode2g | or | 88.13 | 49.03 | 11.40 | 0.47 |
| (24) | manalyze.pefile.opcode2g | or | 86.31 | 45.74 | 13.27 | 0.42 |
| (25) | manalyze.pefile.byte3g | or | 86.28 | 5.44 | 13.13 | 0.60 |
| (26) | manalyze.pefile | or | 86.23 | 1.45 | 12.36 | 1.41 |
| (27) | manalyze.pefile.byte3g.opcode2g | or | 85.82 | 49.73 | 13.88 | 0.30 |
| (28) | manalyze | none | 82.88 | 0.75 | 9.32 | 7.80 |

TABLE 4
Complementary detection performance. For the
detectors presented in each row, we show the detection
accuracy of the other detectors on the files it misclassified.

| | manalyze | pefile | byte3g | opcode2g |
|---|---|---|---|---|
| manalyze | — | 82.96% | 90.09% | 91.01% |
| pefile | 68.96% | — | 73.43% | 78.93% |
| byte3g | 66.24% | 50.32% | — | 60.69% |
| opcode2g | 65.71% | 55.90% | 55.99% | — |

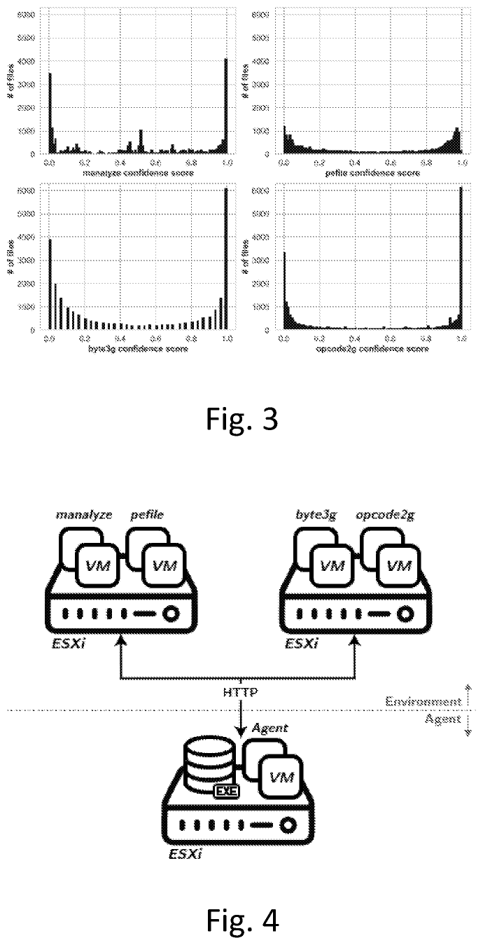

At the next stage, the confidence score distribution of the various detectors was analyzed. The goal of this analysis is to determine whether the detectors are capable of nuanced analysis; It has been hypothesized that detectors which produce multiple values on the [0,1] scale (rather than only “0”s and “1”s) might enable the DRL approach to devise more nuanced policies for selecting detector combinations. The results of the analysis are presented in FIG. 3. While it is clear that all detectors assign either “0”s or “1”s to the majority of the files, a large number of files (particularly for the less-expensive, less-accurate detectors) receive intermediary values. It was therefore concluded that the classifications produced by the detectors are sufficiently diverse to support a nuanced DRL-policy.

At the next stage, a comprehensive analysis on the performance and time consumption for all possible detector combinations is performed, and presented in Table 3 above. To evaluate the performance of each combination, the confidence score was aggregated using three different methods, presented in [12]. The first method “or” classifies a file as malicious if any of the participating detectors classifies it as such (yields a score of 0.5 and above). This method mostly improves the sensitivity, but at the cost of higher percentage of false-positive indications that leads to more benign files classified as malware. The second method “majority” classifies corresponding to the majority of detectors classifications. This means that if most of the detectors classify a file as malware, it will be classified as malware and vice versa. The third method “stacking” learns to combine the classification confidence scores by training a ML model using these scores as its features. In the evaluation, two stacked models were used, Decision Tree (DT) and Random Forest (RF), which were evaluated using 10-fold cross-validation.

The analysis shows that in the case of majority, the optimal performance is not achieved by combining all classifiers, but rather, only three of them. Furthermore, some detector combinations (manalyze, pefile, byte3g) outperform other detector sets, while also being more computationally efficient. The results further support the assumption that an intelligent selection of detector combinations is highly important.

For each file, the times were measured in an isolated computer process on a dedicated machine to prevent other processes interruptions. In addition, the machines executing the detectors were identical and utilized the same hardware and firmware specifications.

The method proposed by the present invention represents an attempt to draft a security policy by performing a cost-benefit analysis that takes into account the resources required to use various detectors. The performance of the proposed method was evaluated in several scenarios and its effectiveness was demonstrated. Moreover, it was shown that simple adjustments to the present invention algorithm's reward function (which reflects the organization's priorities) leads to significant changes in the detection strategy. This method is more effective (and intuitive) than conventional existing methods.

Three VMware ESXi servers were used, each containing two processing units (CPUs). Each server had a total of 32 cores, 512 GB of RAM and 100 TB of SSD disk space. Two servers were used to run the environment and its detectors, while the remaining server housed the DRL agent. In the experiments, two detectors were deployed in each server. This deployment setting can easily be extended to include additional detectors or replicated to increase the throughput of existing ones. The main goal in setting up the environment was to demonstrate a large scale implementation which is both scalable and flexible, thus ensuring its relevance to real-world scenarios.

FIG. 4 shows the infrastructure structure in detail. Both the agent processes and the detectors run on virtual machines with the Ubuntu 18.04 LTS operating system. Each machine has 4 CPU cores, 16 GB of RAM and 100 GB of SSD storage. The agent uses a management service that allows both the training and execution of the DRL algorithm, using different tuning parameters. Upon the arrival of a file for analysis, the agent stores it in a dedicated storage space, which is also accessible to all detectors running in the environment. The agent also utilizes an external storage for storing file and detector-based features, all logging information, and the analysis output. All this information is later indexed and consumed by an analytics engine. The agent communicates with the environment over HTTP protocol.

Setup

The following settings were used in all the experiments:
10-fold cross validation in all experiments, with label ratios maintained for each fold. The results are the averages of all runs.
the framework was implemented using Python v3.6. More specifically, the ChainerRL1 deep reinforcement library was used to create and train the agent, while the environment was implemented using the OpenAI Gym [4].
Both the policy network and the action-value network consist of the following architecture: input layer of size 4 (the state vector's size), a single hidden layer of size 20.
an output layer of size 6 (the size of the action space—four detectors and the two possible classifications). All layers except for the output used the ReLU activation function, while the output layer used softmax.
the initial learning rate was set to 7e-4, with exponential decay rate of 0.99 and a fuzz factor (epsilon) of 1e-2. The chosen optimizer was RMSprop [28]. In all experiments, the model trained until convergence.
the size of the replay buffer was set to 5000. It stared to be used in the training process after 10,000 episodes.
In order to discourage the agent from querying the same detector twice (which is an obvious waste of resources, since no new information is gained), such actions were defined to incur a very large cost of −10,000. The same “fine” applies to attempts to classify a file without using even a single detector.

Experimental Results

The proposed method has two major advantages:

a) it can produce near-optimal performance at reduced computational cost;

b) using rewards allows to easily define and tune the security policies by assigning a “personalized” set of detectors for each file.

To test the robustness of the proposed method, as well as its ability to generalize, five use-cases with varying emphasis on correct/incorrect file classifications and computational cost were defined. The rewards composition of each use-case is presented in Table 5 below, along with its overall accuracy and mean running time.

The computational cost of using a detector is not calculated independently, but rather as a function of correct/incorrect file classification. Additionally, the computational costs of the malware detectors were defined, based on the average execution time of the files that were used for training. This allows the algorithm to converge faster. The experiments show that this type of setting outperforms other approaches for considering computational cost, as it strongly ties the invested resources to the classification outcome.

Experiment 1: In this experiment, both the reward for correct classification and the cost of incorrect classification were set to be equal to the cost of the running time. On one hand, this setting “encourages” the proposed system to invest more time analyzing incoming files and also provides higher rewards for the correct classification of more challenging files. On the other hand, the detector is discouraged from selecting detector configurations that are likely to reduce its accuracy for a given file. Additionally, the method proposed by the present invention will not be inclined to consume additional resources for difficult—to classify cases, where the investment of more time is unlikely to provide additional information.

Experiment 2: The setting of this experiment is similar to that of experiment 1, except for the fact that the cost of incorrect classifications is 10× higher than the reward for correct classifications. It has been assumed that this setting will cause the algorithm to be more risk-averse and invest additional resources for the classification of challenging files.

Experiments 1 and 2 were not designed to assign high priority to resource efficiency, but instead, they focus on accuracy. The remaining experimental settings were designed to assign higher preference to the efficient use of resources.

Experiments 3-5: In this set of experiments, policies where the rewards assigned to correct classification were fixed, while the cost of incorrect classification depends on the amount of computing resources spent has been examined, so as to reach the classification decision. Three variants of this method were explored, where the cost of incorrect classification remains the same, but the rewards for correct classifications are larger by one and two orders of magnitude (1, 10, and 100).

This set of experiments has two main goals: first, since only the cost of an incorrect classification is time-dependent, experiments 3-5 are expected to be more efficiency-oriented. The aim is to determine the size of this improvement and its effect on the accuracy of the proposed method. Secondly, there was an interest in exploring the effect of varying reward/cost ratios on the policy generated by the proposed method. Since scenarios in which the reward for correct classifications is either significantly smaller or larger than the cost of incorrect classifications, have been explored, the expectation was to obtain better understanding of the proposed decision mechanism.

TABLE 5
The cost/reward setup of our experiments.
The function C(t) is presented in Equation 2.

| Exp. | Reward Setup | | | | Accuracy | Mean |
|---|---|---|---|---|---|---|
| # | TP | TN | FP | FN | (%) | Time (sec) |
| 1 | C(t) | C(t) | −C(t) | −C(t) | 96.810 | 49.634 |
| 2 | C(t) | C(t) | −10C(t) | −10C(t) | 96.786 | 49.581 |
| 3 | 1 | 1 | −C(t) | −C(t) | 96.212 | 10.525 |
| 4 | 10 | 10 | −C(t) | −C(t) | 95.424 | 3.681 |
| 5 | 100 | 100 | −C(t) | −C(t) | 91.220 | 0.728 |

A summary of the results is presented in Table 5, while a detailed comparison of the results obtained by the various experiments is shown in Tables 7-10. In addition, a detailed breakdown of the detector combinations used by each of the generated DRL policies is shown in Table 6.

TABLE 6
Distribution of detector combination choices made
by the agent for each of our experimental policies.

| Exp. | Acc. | | Time | Files |
|---|---|---|---|---|
| # | (%) | Action sequences | (sec) | (%) |
| 1 | 96.81 | byte3g, opcode2g, manalyze, pefile | 49.73 | 86.82 |
| | | byte3g, opcode2g, manalyze | 49.03 | 8.40 |
| | | byte3g, opcode2g, pefile | 48.98 | 4.54 |
| | | byte3g, opcode2g | 48.28 | 0.24 |
| 2 | 96.79 | opcode2g, manalyze, pefile, byte3g | 49.73 | 80.11 |
| | | opcode2g, pefile, byte3g | 48.98 | 19.89 |
| 3 | 96.21 | byte3g | 3.99 | 83.38 |
| | | byte3g, pefile, opcode2g | 48.98 | 12.67 |
| | | byte3g, pefile | 4.69 | 2.15 |
| | | byte3g, pefile, opcode2g, manalyze | 49.73 | 1.80 |
| 4 | 95.42 | manalyze, byte3g, pefile | 5.44 | 50.77 |
| | | manalyze, pefile | 1.45 | 22.49 |
| | | manalyze | 0.75 | 16.89 |
| | | manalyze, byte3g | 4.74 | 9.85 |
| 5 | 91.22 | pefile | 0.70 | 96.17 |
| | | pefile, manalyze | 1.45 | 3.83 |

Generally, the results show that the proposed method is capable of generating highly effective detection policies. The policies generated in experiments 1-2 outperformed all the methods presented in the baseline, except for the top-performing policy, which is a combination of all classifiers and the Random Forest algorithm. While this baseline method marginally outperforms the proposed method (98.86% to 96.81% and 96.79% for experiments 1 and 2 respectively), it is also slightly more computationally expensive (49.74 seconds on average compared with 49.63 and 49.58 for experiments 1 and 2 respectively). These results are as expected, since the defined policies for experiments 1 and 2 were geared towards accuracy, rather than efficiency.

TABLE 7
Experiments 1 and 2: costs and rewards are correlated

| Detector | Aggregation | Mean | Mean | FP | FN |
|---|---|---|---|---|---|
| Combination | Method | Acc. (%) | Time (s) | (%) | (%) |
| (1) | stacking (RF) | 96.86 | 49.73 | 1.52 | 1.62 |
| Experiment 1 | ASPIRE | 96.81 | 49.63 | 1.09 | 2.09 |
| Experiment 2 | ASPIRE | 96.79 | 49.58 | 1.80 | 1.39 |
| (2) | majority | 96.71 | 49.03 | 1.45 | 1.84 |
| (3) | majority | 96.65 | 49.73 | 1.40 | 1.95 |
| (4) | majority | 96.37 | 48.28 | 1.65 | 1.98 |
| (5) | majority | 96.30 | 48.98 | 1.61 | 2.09 |

Each of the policies generated by experiments 3-5 achieves a different accuracy/efficiency balance. Moreover, each of the three policies was able to reach accuracy results that are equal to, or better than, those of the corresponding baselines at a much lower cost.

The policy generated by experiment 3 reached an accuracy of 96.21% with a mean time of 10.5 seconds, compared with its closest baseline “neighbor” which achieved an accuracy of 96.3% in a mean time of 48.28 seconds (almost five times longer). Similarly, the policy produced by experiment 4 achieved the same accuracy as its baseline counterpart (pefile, opcode2g) while averagely requiring only 3.68 seconds, compared to the baseline's 45 seconds (92% improvement). The policy generated by experiment 5 averagely requires 0.728 seconds per file, which is comparable to the time required by the baseline method “pefile”. However, the method proposed by the present invention achieves higher accuracy (91.22% vs 90.6%).

TABLE 8
Experiment 3: costs and rewards for incorrect
classifications are correlated. Rewards for correct
classifications are fixed and equal to 1

| Detector | Aggregation | Mean | Mean | FP | FN |
|---|---|---|---|---|---|
| Combination | Method. | Acc. (%) | Time (s) | (%) | (%) |
| (1) | stacking (RF) | 96.86 | 49.73 | 1.52 | 1.62 |
| (2) | majority | 96.71 | 49.03 | 1.45 | 1.84 |
| (3) | majority | 96.65 | 49.73 | 1.40 | 1.95 |
| (4) | majority | 96.37 | 48.28 | 1.65 | 1.98 |
| (5) | Majority | 96.30 | 48.98 | 1.61 | 2.09 |
| Experiment 3 | ASPIRE | 96.21 | 10.53 | 1.96 | 1.82 |
| (6) | majority | 95.98 | 45.74 | 1.77 | 2.25 |

TABLE 9
Experiment 4: costs and rewards for incorrect
classifications are correlated. Rewards for correct
classifications are fixed and equal to 10

| Detector | Aggregation | Mean | Mean | FP | FN |
|---|---|---|---|---|---|
| Combination | Method | Acc. (%) | Time (s) | (%) | (%) |
| (7) | majority | 95.62 | 5.44 | 1.95 | 2.43 |
| (8) | or | 95.57 | 48.28 | 3.23 | 1.20 |
| (9) | majority | 95.56 | 45.04 | 2.12 | 2.32 |
| (10) | none | 95.50 | 44.29 | 2.07 | 2.43 |
| (11) | majority | 95.44 | 44.99 | 2.06 | 2.49 |
| Experiment 4 | ASPIRE | 95.42 | 3.68 | 1.06 | 3.51 |
| (12) | stacking (DT) | 95.16 | 49.73 | 2.48 | 2.36 |
| (13) | majority | 95.15 | 4.74 | 2.43 | 2.43 |
| (14) | none | 94.89 | 3.99 | 1.96 | 3.15 |
| (15) | majority | 94.85 | 4.69 | 2.32 | 2.83 |

TABLE 10
Experiment 5: costs and rewards for incorrect classifications
are correlated. Rewards for correct classifications
are fixed and equal to 100

| Detector | Aggregation | Mean | Mean | FP | FN |
|---|---|---|---|---|---|
| Combination | Method | Acc. (%) | Time (s) | (%) | (%) |
| (19) | majority | 92.40 | 1.45 | 3.47 | 4.14 |
| Experiment 5 | ASPIRE | 91.22 | 0.73 | 3.52 | 5.26 |
| (20) | none | 90.60 | 0.70 | 4.52 | 4.88 |
| . . . | or | . . . | . . . | . . . | . . . |
| (28) | none | 82.88 | 0.75 | 9.32 | 7.80 |

The experiments clearly show that security policy can be very effectively managed using different cost/reward combinations. Moreover, it is clear that using DRL offers much greater flexibility in the shaping of the security policy, than the simple tweaking of the confidence threshold (the only currently available method for most ML-based detection algorithms).

When analyzing the behavior of the policies (i.e., the detector selection strategy), it was found that they behaved just as could be expected. The policies generated by experiments 1 and 2 explicitly favored performance over efficiency, as the reward for correct for correct classification was also time-dependent. As a result, they achieve very high accuracy but only a marginal improvement in efficiency.

For experiments 3-5, the varying fixed cost that was assigned to the correct classifications played a deciding role in creating the policy. In experiment 3, the relative cost of a mistake was often much larger than the reward for a correct classification. Therefore, the generated policy is cautious, while achieving relatively high accuracy (with high efficiency). In experiment 5, the cost of an incorrect classification is relatively marginal, a fact that motivates the generated policy to prioritize speed over accuracy. The policy generated by experiment 4 offers the middle ground, reaching a slightly reduced accuracy compared with experiment 3, but managing to do so in about 33% of the running time.

The main advantage of the proposed method is therefore the ability to craft a “personalized” set of detectors for each file.

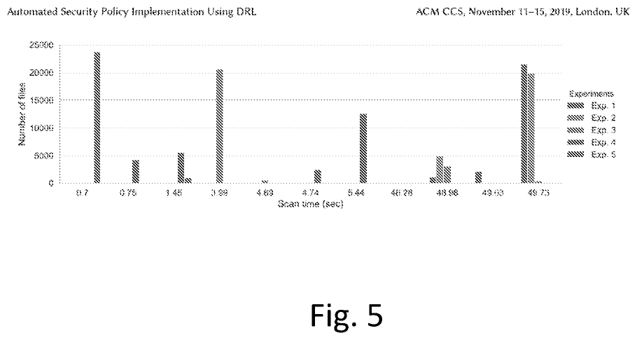

FIG. 5 shows the overall distributions of detector combinations chosen by the policies of all experiments. It is clear that in experiment 4, the policy utilizes multiple detector combinations, which provides the ability to achieve high accuracy at much smaller computational cost. The detector combinations are not chosen in advance but iteratively, with the confidence score of the already-applied detectors used to guide the next step chosen by the policy.

Malware Detection Techniques

The vast variety of ways for representing a PE file allows using different features for malware detection classification models.

The most common and simple way of representing a PE file is by calculating its hash value [9]. Hash values are generated using special function, namely hash functions, that maps data of arbitrary size onto data of a fixed size (commonly represented by numbers and letters). This method is frequently used by anti-virus engines to “mark” and identify malware, as computing hashes is considered fast and efficient.

Additionally, a PE file can be represented using its actual binary data. For example, using byte n-grams (an n-gram is a data structure, originated in computational linguistics, represented by a contiguous sequence of n items usually drawn from a text or speech) to classify malwares has been suggested by [17]. Thus, instead of generating n-grams out of words or characters, [17] suggested generating n-grams out of bytes, while examining different sizes of n-grams ranging from 3 to 6, as well as three feature selection methods. They conducted numerous experiments with four types of models: artificial neural network (ANN), Decision Tree (DT), naïve Bayes (NB) and Support Vector Machine (SVM). DT was able to achieve the best accuracy of 94.3% with less than 4% of false-positives.

Another type of features is generated using the disassembly of a PE file [16]. A disassembler is a computer program that translates code from machine language to the assembly programming language. The translated code includes, among other things, operation codes (opcodes) which are computer instructions that defines the operations to be performed, and often include one or more operands which the instructions will work upon. The use of opcode n-grams to classify malwares was suggested by [16]. They examined different sizes of n-grams ranging from 3 to 6, as well as three feature selection methods. To classify the files, they used several models such as ANN, DT, Boosted DT, NB and Boosted NB. The best results achieved by the DT and the Boosted DT models, with more than 93% accuracy, less than 4% false-positives and less than 17% false-negatives.

Lastly, the PE format (i.e., metadata) can be used to represent the PE file [1, 5, 19]. The format of PE files has a well-defined structure, which includes information necessary to the execution process, as well as some additional data (such as versioning info and creation date). For example, seven features have been used by [19], extracted from the PE headers to classify malicious files: DebugSize, ImageVersion, latRVA, ExportSize, ResourceSize, VirtualSize2, and NumberOfSections were used by several classifiers. To evaluate performance, various classification models have been used, including: IBK, Random Forest, J48, J48 Graft, Ridor and PART.

Their results showed similar performance for all classifiers, reaching an accuracy of up-to 98.56% and a false-positive rate as lower as 5.68%.

Reinforcement Learning in Security Domains

Reinforcement learning is used for various security domains such as adversarial learning and malware detection. For adversarial learning malware detection evading, the system of [1] used RL by trying to attack static PE anti-malware engines by equipping the agent with a set of malicious functionality-preserving operations. The agent learns through a series of games played against the anti-malware engine. In the malware detection domain, the system of [3] showed a proof of concept for adaptive rule-based malware detection employing learning classifier systems, which combines a rule-based expert system. They used VirusTotal as a PE file malware classifier and different static PE file feature using RL algorithm to decide whether PE is malicious or not.

the system of [15] used RL for classifying the type of malware using features used by anti-viruses. Another example used in the malware detection domain was used by the system of [31] for optimizing mobile application malicious behavior on mobile devices by controlling the offloading rate of application traces to the security server. They proposed an offloading strategy based on deep Q-network technique with a deep convolutional neural network to improve the detection speed.

The RL-based method proposed by the present invention for malware detection dynamically and iteratively assigns various detectors to each file, while constantly performing cost-benefit analysis to determine whether the use of a given detector is “worth” the expected reduction in classification uncertainty. The entire process is governed by the organizational policy, which sets the rewards/costs of correct and incorrect classifications and also defines the cost of computational resources.

When compared to existing ensemble-based solution, the proposed method has two main advantages. Firstly, it is highly efficient, since easy-to-classify files are likely to require the use of less powerful classifiers, which allowed maintaining near-optimal performance at a fraction of the computing cost. As a result, it is possible to analyze a much larger number without increasing hardware capacity. Secondly, organizations can clearly and easily define and refine their security policy by explicitly defining the costs of each element of the detection process: correct/incorrect classification and resource usage. Since the value of each outcome is clearly quantified, organizations can easily try different values and fine-tune the performance of their models to comply with the desired outcome.

Although the above examples were directed to malware detection, the proposed method can be implemented in many technologic fields, such as medical tests, detection of various illnesses or medical conditions, diagnostic test, maintenance facilities for vehicles, ships, drones and planes require testing and analysis, in order to optimize the usage of resources, in order to achieve multi-objective tasks with contradicting constrains.

The proposed method may be used to perform several initial tests of modules or components of a system, in order to detect the possibility of an existing problem, and to decide whether or not to conduct additional (and usually, more expensive) tests, as required to meet predetermined needs or organizational policy. This can be applied to any diagnostic process that requires decision making and optimization between contradicting constrains, in order to fulfill a desired policy.

For example, the field of medical diagnostics required performing medical tests, in order to decide which treatment should be given to a patient. However, some test are cheaper and less accurate, while other tests are more expensive and accurate. In this case, the doctor should decide which test are essential for obtaining a good indication regarding the patient's condition. The method proposed by the present invention allows doctors to automatically obtain a minimal set of optimal tests to be performed, in order to obtain fast and accurate diagnostic indication regarding a patient condition, while eliminating unnecessary expensive tests.

In fact, the method proposed by the present invention may be applied almost to any diagnostic field. For example, which tests and inspections should be made to obtain accurate assessment regarding the mechanical condition of a vehicle, an airplane or a ship and which maintenance operations should be taken in order to keep them safe and operative. According to the present invention, a garage can perform some initial test to detect the possibility of some problem, and then conduct additional (and more expensive) tests, only if required.

Also, several sensors may be activated for diagnostic purposes. For example, it is possible to activate various sensors in a mobile device (such as GPS, angle, speed, temperature etc.) to obtain a desired indication. However, each sensor provides some data but consumes different power from the battery. Applying the method proposed by the present invention allows obtaining the desired indication with sufficient accuracy, with the right balance to save battery power. The same applies for unmanned drones that need to detect errors during flight. The proposed method helps optimally allocating their limited resources.

The proposed method can be used for other possible applications, such as detection of malicious websites, fraud detection, evaluating credit risks, routine inspections, optimizing the operation of distributed micro-power grids and predicting power demands along with their timing, traffic and transportation control for optimizing traffic volume and in any environment that requires multi-objective optimization.

According to another embodiment, the proposed system allows to transfer learning from agent to agent. Accordingly, an agent trained in a first environment has transferability feature to function in a second environment, based on its training in the first environment. This save the need to train the agent again and allows use the agent's training to operate in the other environment with minimal adaptation.

### REFERENCES

[1] Hyrum S Anderson, Anant Kharkar, Bobby Filar, and Phil Roth. 2017. Evading machine learning malware detection. Black Hat (2017).
[2] Ross Anderson, Chris Barton, Rainer Bohme, Richard Clayton, Michel J G Van Eeten, Michael Levi, Tyler Moore, and Stefan Savage. 2013. Measuring the Cost of Cybercrime. In The Economics of Information Security and Privacy. Springer, 265-300.
[3] Jonathan J Blount, Daniel R Tauritz, and Samuel A Mulder. 2011. Adaptive RuleBased Malware Detection Employing Learning Classifier Systems: A Proof of Concept. In 2011 IEEE 35th Annual Computer Software and Applications Conference Workshops. IEEE, 110-115.
[4] Greg Brockman, Vicki Cheung, Ludwig Pettersson, Jonas Schneider, John Schulman, Jie Tang, and Wojciech Zaremba. 2016. OpenAI Gym. arXiv:arXiv:1606.01540
[5] Young Han Choi, Byoung Jin Han, Byung Chul Bae, Hyung Geun Oh, and Ki Wook Sohn. 2012. Toward extracting malware features for classification using static and dynamic analysis. In 2012 8th International Conference on Computing and Networking Technology (INC, ICCIS and ICMIC). IEEE, 126-129.
[6] Anusha Damodaran, Fabio Di Troia, Corrado Aaron Visaggio, Thomas H Austin, and Mark Stamp. 2017. A comparison of static, dynamic, and hybrid analysis for malware detection. Journal of Computer Virology and Hacking Techniques 13, 1 (2017), 1-12.
[7] Mojtaba Eskandari, Zeinab Khorshidpour, and Sattar Hashemi. 2013. HDMAnalyser: a hybrid analysis approach based on data mining techniques for malware detection. Journal of Computer Virology and Hacking Techniques 9, 2 (2013), 77-93.
[8] Yarin Gal and Zoubin Ghahramani. 2016. Dropout as a bayesian approximation: Representing model uncertainty in deep learning. In international conference on machine learning. 1050-1059.
[9] Kent Griffin, Scott Schneider, Xin Hu, and Tzi-Cker Chiueh. 2009. Automatic Generation of String Signatures for Malware Detection. In International workshop on recent advances in intrusion detection. Springer, 101-120.
[10] Jiegiong Hou, Minhui Xue, and Haifeng Qian. 2017. Unleash the Power for Tensor: A Hybrid Malware Detection System Using Ensemble Classifiers. In 2017 IEEE International Symposium on Parallel and Distributed Processing with Applications and 2017 IEEE International Conference on Ubiquitous Computing and Communications (ISPA/IUCC). IEEE, 1130-1137.
[11] Nwokedi Idika and Aditya P Mathur. 2007. A survey of malware detection techniques. Purdue University 48 (2007).
[12] Khaled N Khasawneh, Meltem Ozsoy, Caleb Donovick, Nael Abu-Ghazaleh, and Dmitry Ponomarev. 2015. Ensemble Learning for Low-level Hardware-supported Malware Detection. In International Symposium on Recent Advances in Intrusion Detection. Springer, 3-25.
[13] Long-Ji Lin. 1992. Self-improving reactive agents based on reinforcement learning, planning and teaching. Machine learning 8, 3-4 (1992), 293-321.
[14] Volodymyr Mnih, Koray Kavukcuoglu, David Silver, Andrei A Rusu, Joel Veness, Marc G Bellemare, Alex Graves, Martin Riedmiller, Andreas K Fidjeland, Georg Ostrovski, et al. 2015. Human-level control through deep reinforcement learning. Nature 518, 7540 (2015), 529.
[15] Sepideh Mohammadkhani and Mansour Esmaeilpour. 2018. A new method for behavioural-based malware detection using reinforcement learning. International Journal of Data Mining, Modelling and Management 10, 4 (2018), 314-330.
[16] Robert Moskovitch, Clint Feher, Nir, Tzachar, Eugene Berger, Marina Gitelman, Shlomi Dolev, and Yuval Elovici. 2008. Unknown Malcode Detection Using OPCODE Representation. In European Conference on Intelligence and Security Informatics. Springer, 204-215.
[17] Robert Moskovitch, Dima Stopel, Clint Feher, Nir Nissim, and Yuval Elovici. 2008. Unknown malcode detection via text categorization and the imbalance problem. In 2008 IEEE International Conference on Intelligence and Security Informatics. IEEE, 156-161.
[18] Radu S Pirscoveanu, Steven S Hansen, Thor M T Larsen, Matija Stevanovic, Jens Myrup Pedersen, and Alexandre Czech. 2015. Analysis of malware behavior: Type classification using machine learning. In 2015 International Conference on Cyber Situational Awareness, Data Analytics and Assessment (CyberSA). IEEE, 1-7.
[19] Karthik Raman et al. 2012. Selecting Features to Classify Malware. InfoSec Southwest 2012 (2012).
[20] Konrad Rieck, Philipp Trinius, Carsten Willems, and Thorsten Holz. 2011. Automatic Analysis of Malware Behavior Using Machine Learning. Journal of Computer Security 19, 4 (2011), 639-668.
[21] John Schulman, Sergey Levine, Pieter Abbeel, Michael Jordan, and Philipp Moritz. 2015. Trust region policy optimization. In International Conference on Machine Learning. 1889-1897.
[22] Christian Robert Shelton. 2001. Importance Sampling for Reinforcement Learning with Multiple Objectives. (2001).
[23] PV Shijo and A. Salim. 2015. Integrated Static and Dynamic Analysis for Malware Detection. Procedia Computer Science 46 (2015), 804-811.
[24] David Silver, Aja Huang, Chris J Maddison, Arthur Guez, Laurent Sifre, George Van Den Driessche, Julian Schrittwieser, loannis Antonoglou, Veda Panneershelvam, Marc Lanctot, et al. 2016. Mastering the game of Go with deep neural networks and tree search. nature 529, 7587 (2016), 484.
[25] David Silver, Julian Schrittwieser, Karen Simonyan, loannis Antonoglou, Aja Huang, Arthur Guez, Thomas Hubert, Lucas Baker, Matthew Lai, Adrian Bolton, et al. 2017. Mastering the game of go without human knowledge. Nature 550, 7676 (2017), 354.
[26] Felipe Petroski Such, Vashisht Madhavan, Edoardo Conti, Joel Lehman, Kenneth O Stanley, and Jeff Clune. 2017. Deep neuroevolution: Genetic algorithms are a competitive alternative for training deep neural networks for reinforcement learning. arXiv preprint arXiv:1712.06567 (2017).
[27] Richard S Sutton and Andrew G Barto. 2018. Reinforcement Learning: An Introduction (2nd ed.). MIT press Cambridge.
[28] Tijmen Tieleman and Geoffrey Hinton. 2012. Lecture 6.5-rmsprop: Divide the gradient by a running average of its recent magnitude. COURSERA: Neural networks for machine learning 4, 2 (2012), 26-31.
[29] Scott Treadwell and Mian Zhou. 2009. A heuristic approach for detection of obfuscated malware. In 2009 IEEE International Conference on Intelligence and Security Informatics. IEEE, 291-299.
[30] Joannes Vermorel and Mehryar Mohri. 2005. Multi-armed Bandit Algorithms and Empirical Evaluation. In European Conference on Machine Learning. Springer, 437-448.
[31] Xiaoyue Wan, Geyi Sheng, Yanda Li, Liang Xiao, and Xiaojiang Du. 2017. Reinforcement Learning Based Mobile Offloading for Cloud-Based Malware Detection. In GLOBECOM 2017-2017 IEEE Global Communications Conference. IEEE, 1-6.
[32] Ziyu Wang, Victor Bapst, Nicolas Heess, Volodymyr Mnih, Remi Munos, Koray Kavukcuoglu, and Nando de Freitas. 2016. Sample Efficient Actor-Critic with Experience Replay. arXiv:1611.01224 (2016).
[33] Ilsun You and Kangbin Yim. 2010. Malware Obfuscation Techniques: A Brief Survey. In 2010 International Conference on Broadband, Wireless Computing, Communication and Applications. IEEE, 297-300.

1. An automatic computer implemented method for making classification decisions to provide a desired policy that optimizes multi-objective tasks with contradicting constrains, comprising:
a) defining time and resources constrains that correspond to a predetermined level of acceptable cost;
b) defining a cost function that represents said acceptable cost while considering said constrains;
c) providing a plurality of analysis and processing modules in a computational environment, for processing data associated with said computational environment and returning results, along with indications regarding the level of confidence of said results;
d) providing at least one agent being a software module, for evaluating the results returned by each analysis and processing module, using a neural network being trained to dynamically determine when said level of confidence is sufficient, using one module, and if found insufficient, using more analysis and processing modules;
e) assigning rewards to sufficient levels and penalties to insufficient levels;
f) assigning penalties to the usage of resources;
g) assigning penalties to runtime using a RL framework for exploring the efficacy of various modules combinations and continuously performing cost-benefit analysis; and
h) using RL framework for analyzing the required consumed resources and processing time corresponding to said cost function and selecting the optimal combinations of analysis and processing modules to implement said policy.

2. A method according to claim 1, wherein various processing modules are sequentially queried for indications, while after each sequential step, deciding whether or not to perform further analysis by other processing modules.

3. A method according to claim 1, wherein the reinforcement learning algorithms are designed to operate, based on partial data, without running all processing modules in advance.

4. A method according to claim 1, wherein a single processing module is interactively selected, while during each iteration, the performance of said selected detector is evaluated, to determine whether the benefit of using additional processing modules is likely to be worth the cost of using said additional processing modules.

5. A method according to claim 1, wherein the selection of processing modules is dynamic, while using different modules combinations for different scenarios.

6. A method according to claim 1, wherein the time required to run a processing module represents the approximated cost of its activation.

7. A method according to claim 1, wherein the computational cost of using a processing module is calculated as a function of its level of confidence.

8. A method according to claim 1, wherein the security policy is managed using different cost/reward combinations.

9. A method according to claim 1, wherein the detector combinations are not chosen in advance but iteratively, with the confidence level of the already-applied detectors used to guide the next step chosen by the policy.

10. A method according to claim 1, wherein an agent trained in a first environment has transferability feature to function in a second environment, based on training in said first environment.

11. An automatic computer implemented method for making classification decisions to provide a desired policy reflecting organizational priorities, that optimizes between multi-objective tasks with contradicting constrains, comprising:
a) defining time and computational resources constrains that correspond to predetermined a level of acceptable cost;
b) defining a cost function that represents said acceptable cost while considering said constrains;
c) providing a plurality of detectors deployed in a computational environment, for classifying one or more received data files associated with said computational environment;
d) providing at least one agent for evaluating the classification results of each detector using a deep neural network being trained to dynamically determine when there is sufficient information to classify said data file using one detector, and if found insufficient, using more detectors;
e) assigning rewards to correct file classification and penalties to incorrect file classification;
f) assigning rewards to the usage of computing resources being below a predetermined level and penalties to the usage of computing resources exceeding said predetermined level;
g) assigning rewards to runtime being below a predetermined level and penalties to runtime exceeding said predetermined level using a RL framework for exploring the efficacy of various detector combinations and continuously performing cost-benefit analysis;
h) using RL framework for analyzing said cost function and selecting the optimal detector combinations for said policy.

12. A method according to claim 11, wherein various detectors are sequentially queried for each file, while after each sequential step, deciding whether or not to further analyze the file or to produce final classification.

13. A method according to claim 11, wherein the reinforcement learning algorithms are designed to operate, based on partial knowledge, without running all detectors in advance.

14. A method according to claim 11, wherein a single detector is interactively selected, while during each iteration, the performance of said selected detector is evaluated, to determine whether the benefit of using additional detectors is likely to be worth the computational cost of said additional detectors.

15. A method according to claim 11, wherein the selection of detectors is dynamic, while using different detector combinations for different scenarios.

16. A method according to claim 11, wherein the states that characterize the environment consist of all possible score combinations by the participating detectors.

17. A method according to claim 11, wherein the initial state for each incoming file is a vector entirely consisting of −1 values and after various detectors are chosen to analyze the files, entries in the vector are populated with the confidence scores they provide.

18. A method according to claim 11, wherein the rewards reflect the organizational security policy, being the tolerance for errors in the detection process and the cost of using computing resources.

19. A method according to claim 11, wherein the time required to run a detector represents the approximated cost of its activation.

20. A method according to claim 11, wherein the cost function of the computing time is defined as
$$C ( t ) = \{ \begin{matrix}t & if 0 \leq t \leq 1 \\ min \{ 1 + {log}_{2} ( t ) , 6 \} & if t > 1\end{matrix} \qquad ( 2 )$$

21. A method according to claim 11, wherein the cost to be considered is adapted to include one or more of the following additional resources:
memory usage;
CPU runtime;
cloud computing costs;
electricity consumption.

22. A method according to claim 11, wherein the detectors are selected from the group of pefile, byte3g, opcode2g, and manalyze.

23. A method according to claim 11, wherein the computational cost of using a detector is calculated as a function of correct/incorrect file classification.

24. A method according to claim 11, wherein the computational costs of the detectors were defined, based on the average execution time of the files that were used for training.

25. A method according to claim 11, wherein the reward for correct classification and the cost of incorrect classification are set to be equal to the cost of the running time.

26. A method according to claim 11, wherein the security policy is managed using different cost/reward combinations.

27. A method according to claim 11, wherein the detector combinations are not chosen in advance but iteratively, with the confidence score of the already-applied detectors used to guide the next step chosen by the policy.

28. A method according to claim 11, wherein the computational environment includes malware detection in data files.

29. A method according to claim 11, wherein the computational environment includes medical data files.

30. A method according to claim 11, wherein the reward for correct classification and the penalty for correct classification are time dependent.

31. A method according to claim 11, wherein the reward for correct classification is fixed and the penalty for correct classification is time dependent.

32. A method according to claim 11, wherein an agent trained in a first environment has transferability feature to function in a second environment, based on training in said first environment.

33. A method according to claim 1, wherein the environment includes one of the following:
Detection of malicious websites;
Fraud detection;
Evaluating credit risks;
Maintenance and routine inspections;
Optimized micro-power grids;
Traffic and transportation control;
an environment that requires multi-objective optimization.

34. A computerized system for making classification decisions to provide a desired policy that optimizes multi-objective tasks with contradicting constrains, comprising:
a) a plurality of analysis and processing modules in a computational environment, for processing data associated with said computational environment and returning results, along with indications regarding the level of confidence of said results;
b) at least one processor and associated memory, adapted to:
b.1) store and run at least one agent being a software module, for evaluating the results returned by each analysis and processing module using a neural network, being trained to dynamically determine when said level of confidence is sufficient, using one analysis and processing module, and if found insufficient, using more analysis and processing modules;
b.2) assign rewards to sufficient levels and penalties to insufficient levels;
b.3) assign penalties to the usage of resources;
b.4) assign penalties to runtime using a RL framework for exploring the efficacy of various modules combinations and continuously performing cost-benefit analysis; and
b.5) use RL framework for analyzing the required consumed resources and processing time corresponding to said cost function and selecting the optimal combinations of analysis and processing modules to implement said policy.
